(19) United States
(12) Patent Application Publication
(10) Pub. No.: US 2019/0255696 A1
(43) Pub. Date: Aug. 22, 2019

(54) TOOL HOLDING SYSTEM AND DEVICE

(71) Applicant: Andre A Woolery, Miami (CA)

(72) Inventor: Andre A Woolery, Miami (CA)

(21) Appl. No.: 16/279,816

(22) Filed: Feb. 19, 2019

Related U.S. Application Data
(60) Provisional application No. 62/633,984, filed on Feb. 22, 2018.

(51) Int. Cl. B25H 3/02

(52) U.S. Cl. CPC B25H 3/028; B25H 3/022

(57) ABSTRACT

A tool holding system and device comprises a tool holder comprising a primary storage compartment for removably holding one or more tools and a secondary storage compartment configured to removably receive a parts bin. The parts bin is configured to removably hold one or more additional tools.

### RELATED APPLICATIONS

This Patent Application claims priority under 35 U.S.C. 119(e) of the co-pending U.S. Provisional Patent Application, application Ser. No. 62/633,984, filed on Feb. 22, 2018, and entitled “TOOL HOLDING SYSTEM AND DEVICE,” which is also hereby incorporated by reference in its entirety.

### FIELD OF THE INVENTION

The present invention is generally directed to tool holding systems and devices. More particularly, the present invention is directed to a tool holding system and device with a primary and secondary storage compartment.

### BACKGROUND OF THE INVENTION

Tools including, tape measures, levels, pliers, screw drivers, wrenches, hammers, power tools and others are an integral part of the professional and amateur tool kit. In particular, many projects require multiple tools to be used interchangeably throughout the course of the project. These projects may also require multiple parts and/or fasteners for completion of the project.

### SUMMARY OF THE INVENTION

A tool holding system and device comprises a tool holder comprising a primary storage compartment for removably holding one or more tools and a secondary storage compartment configured to removably receive a parts bin. The parts bin is configured to removably hold one or more additional tools.

In one aspect, a tool holding system comprises a parts bin configured to removably hold one or more additional tools and a tool holder comprising a primary storage compartment for removably holding one or more tools and a secondary storage compartment configured to removably receive the parts bin. In some embodiments, the secondary storage compartment comprises a form fitting opening configured for receiving a complementary shaped parts bin. In some embodiments, the parts bin is configured to hold one or more additional tools for use with the one or more tools removably held within the primary storage compartment. In some embodiments, wherein the primary storage compartment is closable. In further embodiments, a flap removably covers the secondary storage compartment. In some of these embodiments, the flap is one of foldable in place and zippable in place. In some embodiments, the secondary storage compartment is built into the tool holder. In some embodiments, the secondary storage compartment comprises a top wall so that items are able to be placed within the primary storage compartment when the parts bin is removed from the secondary storage compartment. In further embodiments, the secondary storage compartment is accessible from a back side of the tool holder. In some embodiments, the tool holder comprises one or more exterior pockets.

In another aspect, a tool holding device comprises a body comprising a primary storage compartment accessed from a top of the body and for removably holding one or more tools and a secondary storage compartment built into the body and configured to removably receive a parts bin. In some embodiments, the secondary storage compartment comprises a form fitting opening configured for receiving a complementary shaped parts bin. In some embodiments, the parts bin is configured to hold one or more additional tools for use with the one or more tools removably held within the primary storage compartment. In some embodiments, wherein the primary storage compartment is closable. In further embodiments, a flap removably covers the secondary storage compartment. In some of these embodiments, the flap is one of foldable in place and zippable in place. In some embodiments, the secondary storage compartment is built into the tool holder. In some embodiments, the secondary storage compartment comprises a top wall so that items are able to be placed within the primary storage compartment when the parts bin is removed from the secondary storage compartment. In further embodiments, the secondary storage compartment is accessible from a back side of the tool holder. In some embodiments, the tool holder comprises one or more exterior pockets.

In a further aspect, a method of using a tool holder comprises removably storing one or more tools within a primary storage compartment of the tool holder and removably inserting a parts bin into a secondary storage compartment of the tool holder, wherein the secondary storage compartment is built into a body of the tool holder. In some embodiments, the parts bin is configured to hold one or more additional tools for use with the one or more tools removably held within the primary storage compartment. In some embodiments, the method further comprises closing primary storage compartment. In some embodiments, the method further comprises covering the secondary storage compartment with a flap. In some of these embodiments, the flap is zippable in place.

### BRIEF DESCRIPTIONS OF THE DRAWINGS

Several example embodiments are described with reference to the drawings, wherein like components are provided with like reference numerals. The example embodiments are intended to illustrate, but not to limit, the invention. The drawings include the following figures:

FIGS. 1A-1C illustrate a tool holding system and device, in accordance with some embodiments.

FIG. 2 illustrates a tool holding system and device, in accordance with some embodiments.

FIG. 3 illustrates a tool holding system and device, in accordance with some embodiments.

FIG. 4 illustrates a method of using a tool holder, in accordance with some embodiments.

FIGS. 5A-5C illustrate a tool holding system and device, in accordance with some embodiments.

FIG. 6 illustrates a tool holding system and device, in accordance with some embodiments.

FIG. 7 illustrates a tool holding system and device, in accordance with some embodiments.

### DETAILED DESCRIPTION OF THE PRESENT INVENTION

Embodiments of the invention are directed to tool holding system and device comprises a tool holder comprising a primary storage compartment for removably holding one or more tools and a secondary storage compartment configured to removably receive a parts bin. The parts bin is configured to removably hold one or more additional tools.

Reference will now be made in detail to implementations of a tool holding system and device as illustrated in the accompanying drawings. In the interest of clarity, not all of the routine features of the implementations described herein are shown and described. It will be appreciated that in the development of any such actual implementation, numerous implementation-specific decisions can be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

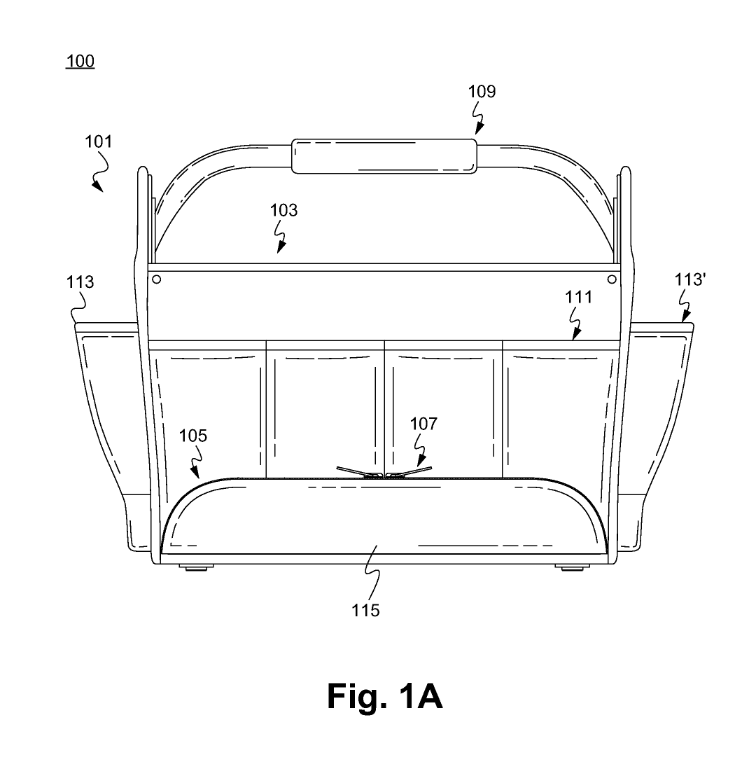

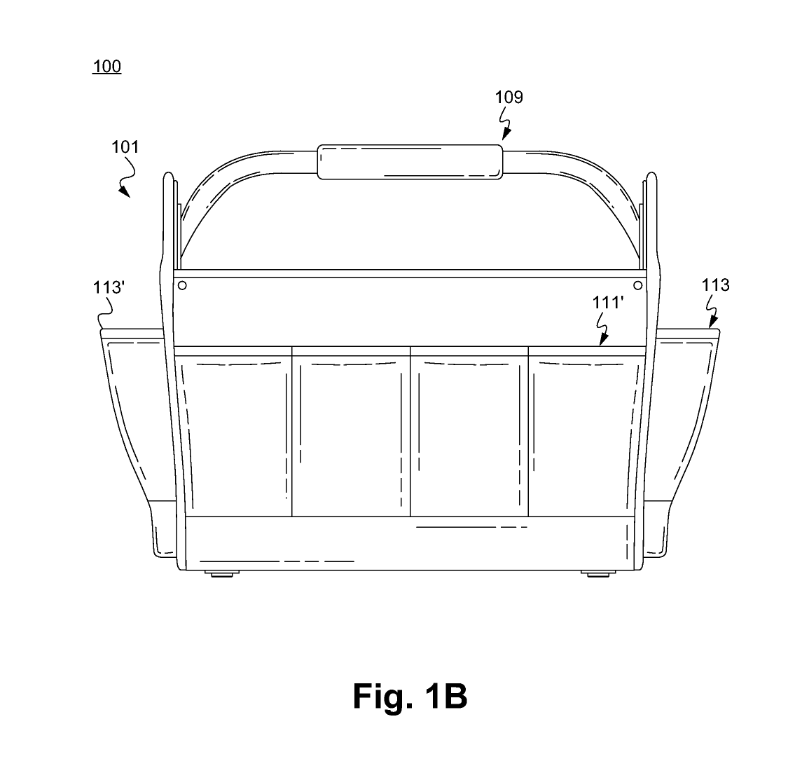

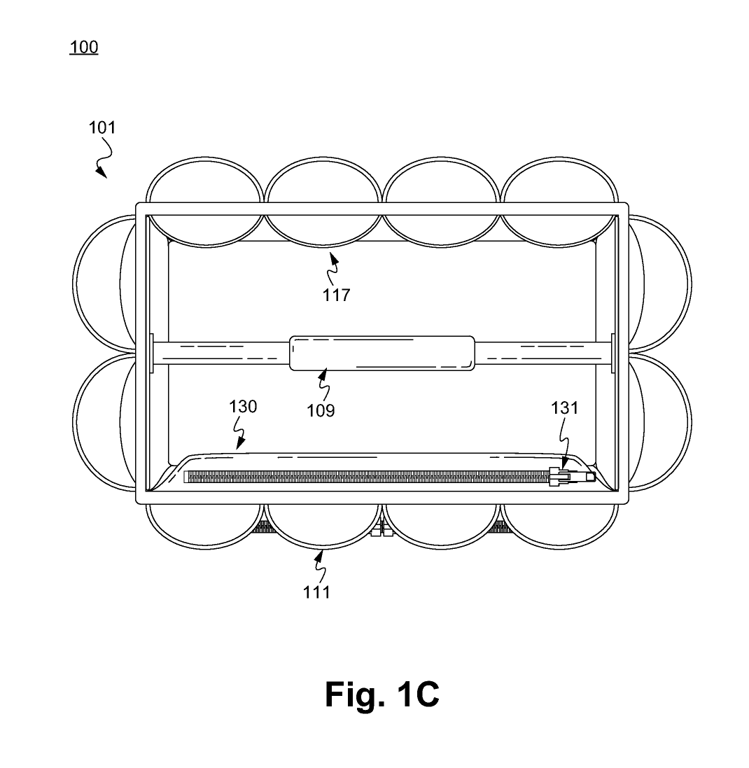

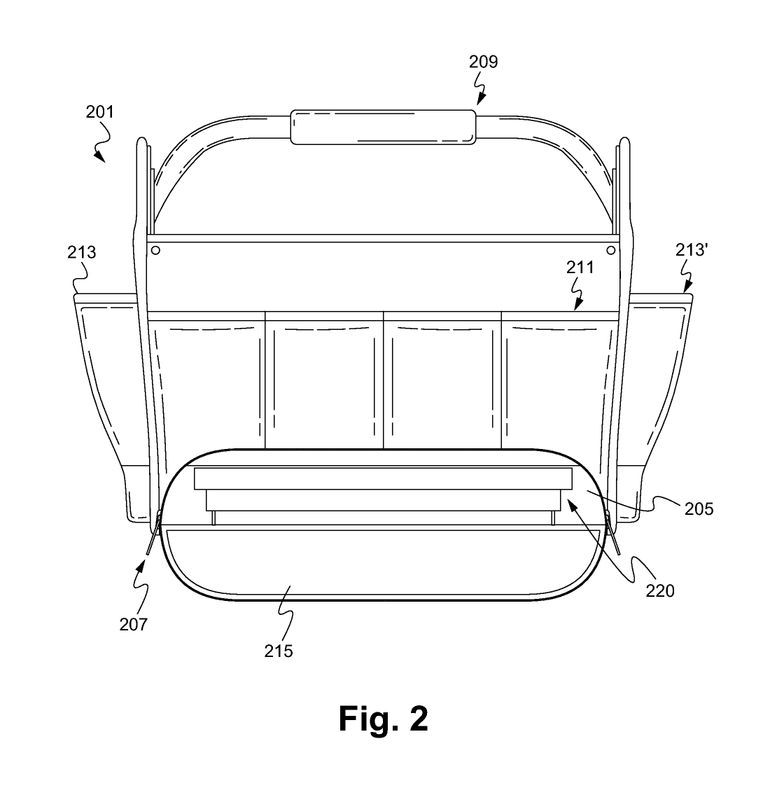

Referring now to FIG. 1A, a tool holding system is depicted therein. The tool holding system 100 comprises a body 101 comprising a tool holder. The body 101 comprises a primary storage compartment 103 configured to removably store one or more tools and a secondary storage compartment 105 configured to removably store a parts bin (FIG. 2) and a handle 109. The parts bin is configured to removably receive one or more additional tools. As shown within FIG. 1A, in some embodiments, the tool holder body 101 comprises a flap 115 which covers the secondary storage compartment 105. For example, in some embodiments, the secondary storage compartment 105 is accessed by unzipping the flap 115 using a zipper 107. In some embodiments, the flap 115 comprises a ridged material which is folded down to access the secondary storage compartment 105. However, the flap 115 is able to comprise any appropriately desired material and/or configuration for covering the secondary storage compartment 105. As shown within FIG. 1A, the secondary storage compartment 105 is built into a body of the tool holder 101. In some embodiments, the secondary storage compartment 105 comprises a top wall so that items are able to be placed within the primary storage compartment 103 when the parts bin is removed from the secondary storage compartment 105.

In some embodiments, the primary storage compartment 103 is accessed from a top of the body and is open. In this configuration, one or more tools are able to be placed within the primary storage compartment 103 through the open top. Alternatively, in some embodiments, the primary storage compartment 103 is accessed by opening a lid of the tool system. As shown within FIG. 1A, in some embodiments, the body 101 comprises one or more external pockets 111. In some embodiments, the body 101 further comprises a left side pocket 113 and a right side pocket 113′. Particularly, the body 101 is able to comprise any appropriately desired amount of exterior pockets. In some embodiments, the exterior pockets are configured to removably hold one or more tools.

FIG. 1B illustrates a back view of the tool holding system 100 as described above. The system 100 comprises a tool holder body 101, comprises a primary storage compartment 103 configured to removably store one or more tools and a secondary storage compartment configured to removably store a parts bin and a handle 109. In some embodiments, the secondary compartment is also accessible from the backside by means of a flap, such as described above. As shown within FIG. 1B, in some embodiments, the back of the tool holder body 101 comprises one or more pockets 111′.

As shown within FIG. 1C, in some embodiments, the primary storage compartment 103 comprises one or more internal pockets 117. Additionally, in some embodiments, the primary storage compartment 103 comprises a zippable pocket 130 that is able to be opened and closed using a zipper 131. Particularly, the primary storage compartment 103 is able to comprise any appropriately desired number of pockets.

FIG. 2 illustrates a tool holding system and device, in accordance with some embodiments. As shown within FIG. 2, the tool holder body 201 comprises a primary storage compartment 203 configured to removably store one or more tools and a secondary storage compartment 205 configured to removably store a parts bin 220 and a handle 209, such as described above.

As described above, the parts bin 220 is configured to removably receive one or more additional tools. As shown within FIG. 2, the flap 215 is in an open configuration and the parts bin 220 is accessible within the secondary storage compartment 205. As further shown within FIG. 2, a zipper 207 is used to open the flap 215 for accessing the secondary storage compartment 205. However, as described above, the flap 215 is able to comprise any appropriately desired material and configuration for covering the secondary storage compartment 205. In some embodiments, the secondary storage compartment 205 comprises a form fitting opening configured for receiving a complementary shaped parts bin 220. As shown within FIG. 2, the secondary storage compartment 205 is built into a body of the tool holder 201.

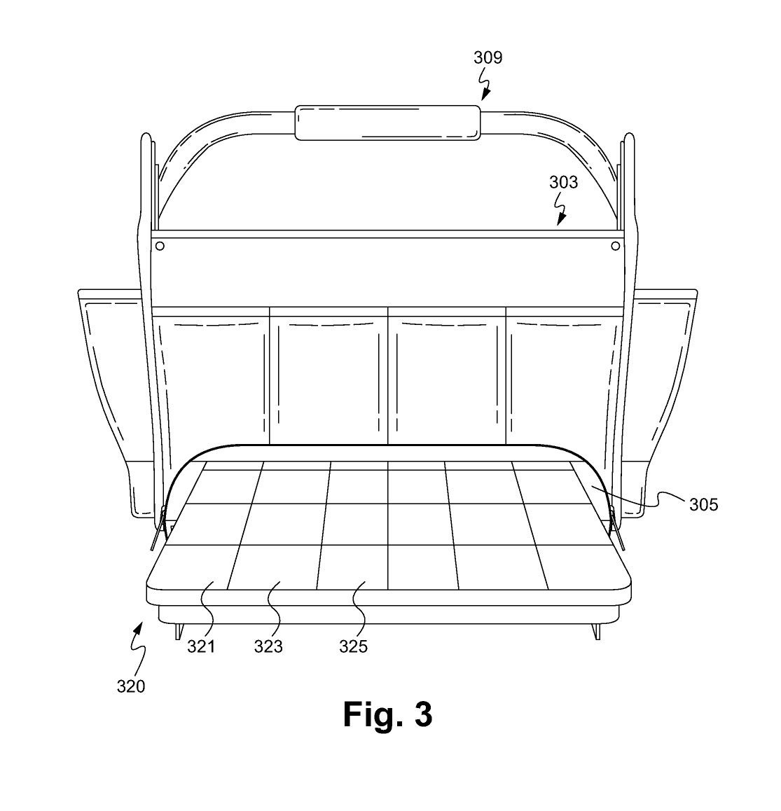

FIG. 3 illustrates a parts bin 320 removed from a secondary storage compartment 305 in accordance with some embodiments. As described above, the parts bin 320 is configured to hold one or more additional tools. In some embodiments, the parts bin 320 is configured to hold one or more additional tools designed to be used with a tool held within the primary storage compartment 303. For example, if a hammer is stored within the primary storage compartment 303, then the parts bin 320 is able to hold a plurality of different sized nails for use with the hammer Alternatively, or in conjunction, if a drill is stored within the primary storage compartment 303, then the parts bin 320 is able to hold a plurality of different drill bits and/or screws for use with the drill. In some embodiments, the parts bin 320 is configured to hold parts such as nails, screws, bolts, nuts, washers and other small tools. In some embodiments, the parts bin 320 is able to hold one or more hand tools that are too small to be held within the primary storage compartment 303. Particularly, the parts bin 320 is able to hold any appropriately desired tools.

In some embodiments, such as shown within FIG. 3, the parts bin 320 comprises a plurality of compartments 321, 323, and 325 for removably storing one or more additional tools. Particularly, the parts bin 320 is able to comprise any appropriately desired amount and configuration of compartments for storing the one or more additional tools. As described above, in some embodiments the parts bin 320 is accessible from a front and a back of the tool holder body 301.

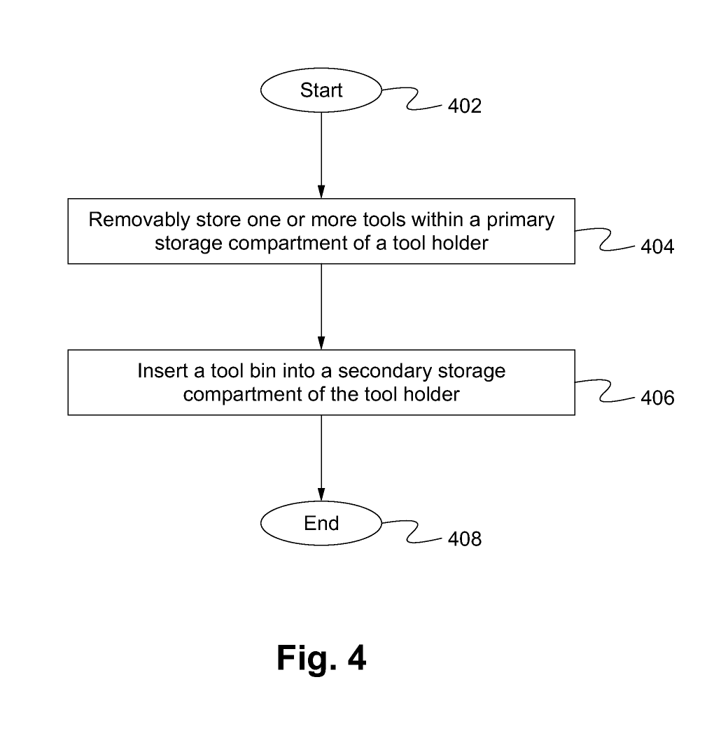

FIG. 4 illustrates a method of using a tool holder such as described above and below. The method begins in the step 402. In the step 404, one or more tools are removably stored within a primary storage compartment of the tool holder. Then, in the step 406, a parts bin is inserted into a secondary storage compartment of the tool holder. As described above, the secondary storage compartment is built into a body of the tool holder. The method ends in the step 408. As described above, the parts bin is configured to hold one or more additional tools. As further described n some embodiments, the parts bin is configured to hold one or more additional tools designed to be used with a tool held within the primary storage compartment.

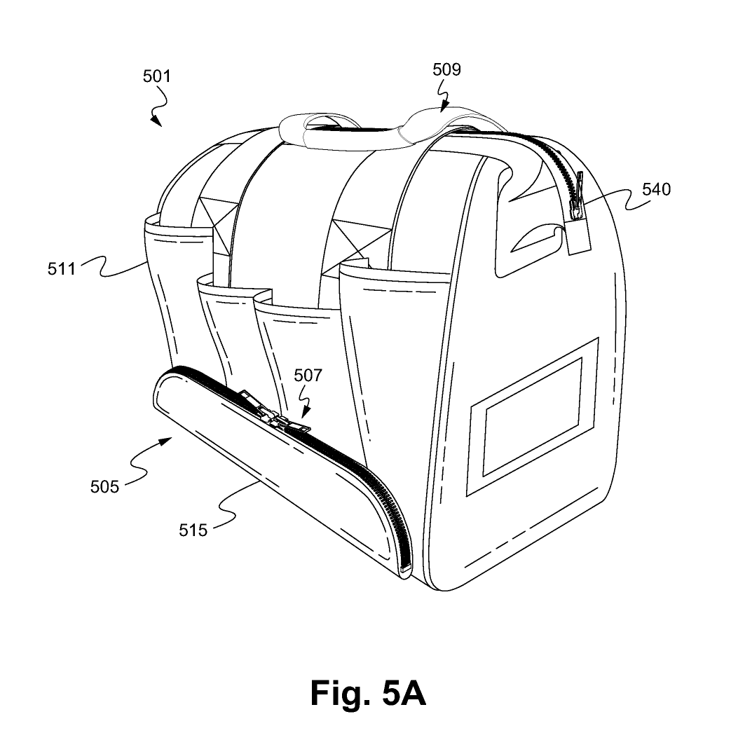

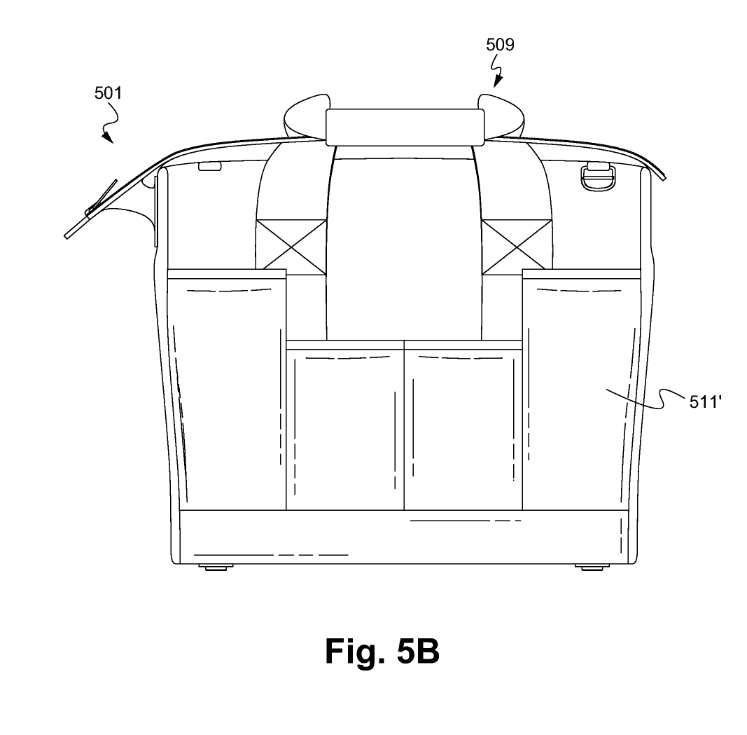

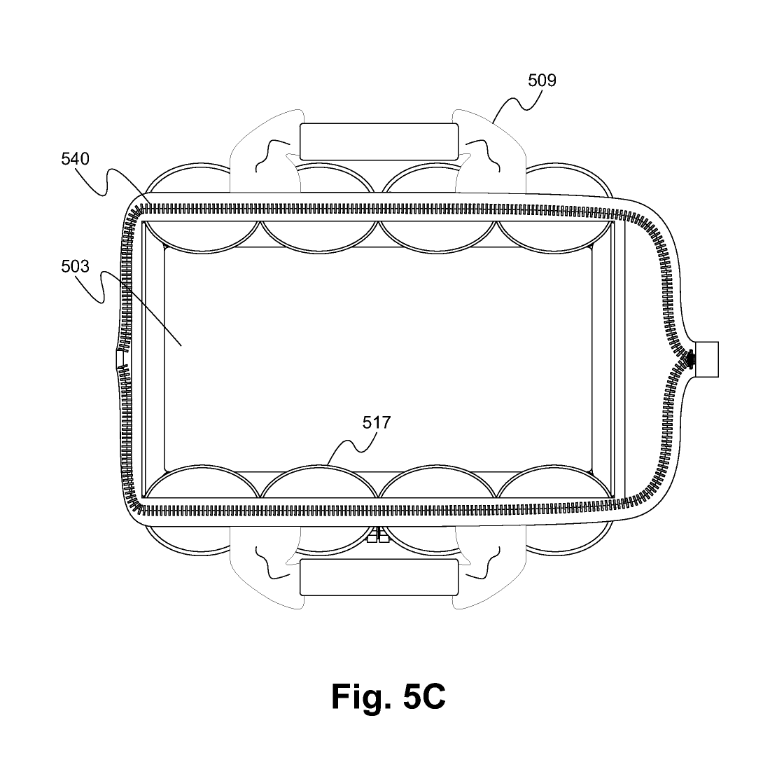

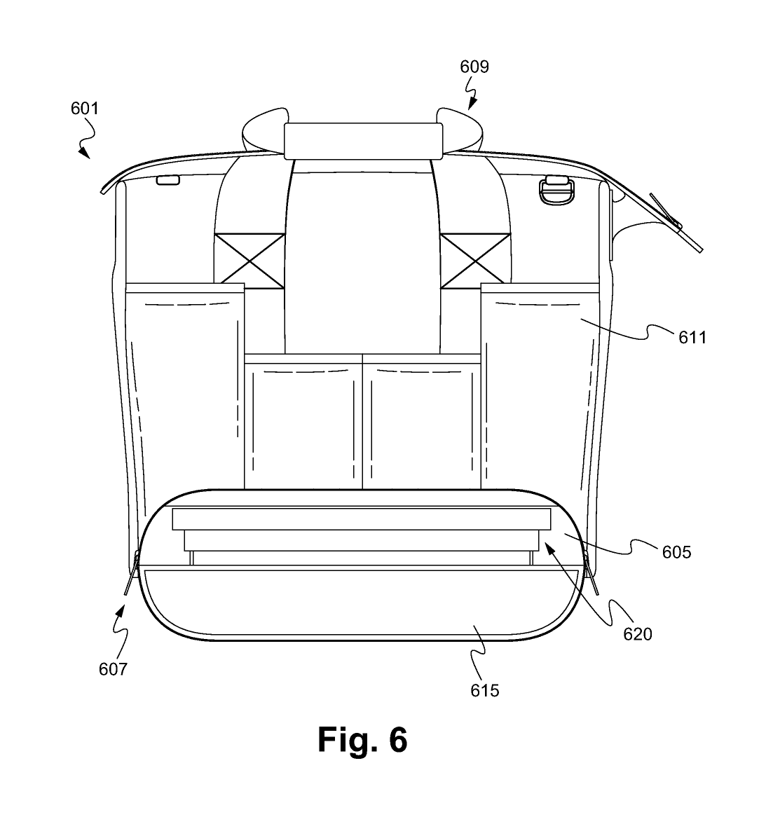

In some embodiments, the tool holding system comprises a closeable primary storage compartment. Referring now to FIG. 5A, a tool holding system is depicted therein. The tool holding system 500 is similar to the tool holding system such as described above. The tool holding system 500 comprises a body 501 comprising a tool holder. The body 501 comprises a primary storage compartment 503 (FIG. 5C) configured to removably store one or more tools and a secondary storage compartment 505 configured to removably store a parts bin (FIG. 6) and a handle 509. The parts bin is configured to removably receive one or more additional tools. As shown within FIG. 5A, in some embodiments, the tool holder body 505 comprises a flap 515 which covers the secondary storage compartment 505. For example, in some embodiments, the secondary storage compartment 505 is accessed by unzipping the flap 515 using a zipper 507. In some embodiments, the flap 515 comprises a ridged material which is folded down to access the secondary storage compartment 505. However, the flap 515 is able to comprise any appropriately desired material and/or configuration for covering the secondary storage compartment 505. As shown within FIG. 5A, the secondary storage compartment 505 is built into a body of the tool holder 505. In some embodiments, the secondary storage compartment 505 comprises a top wall so that items are able to be placed within the primary storage compartment 503 when the parts bin is removed from the secondary storage compartment 505.

In some embodiments, the primary storage compartment 503 is accessed from a top of the body. In some embodiments, the primary storage compartment 503 is accessed by opening a closed primary storage compartment 503. For example, such as shown within FIG. 5A, the primary compartment 503 is accessed by unzipping a zipper 540 of the primary storage compartment 503. When the primary storage compartment 503 is open, one or more tools are able to be placed within the primary storage compartment 503 through the open top. Alternatively, in some embodiments, the primary storage compartment 503 is accessed by opening a lid of the tool system. As shown within FIG. 5A, in some embodiments, the body 501 comprises one or more external pockets 511. Particularly, the body 501 is able to comprise any appropriately desired amount of exterior pockets. In some embodiments, the exterior pockets are configured to removably hold one or more tools.

FIG. 5B illustrates a back view of the tool holding system 500 as described above. The system 500 comprises a tool holder body 501, comprises a primary storage compartment 503 configured to removably store one or more tools and a secondary storage compartment configured to removably store a parts bin and a handle 509. In some embodiments, the secondary compartment is also accessible from the backside by means of a flap, such as described above. As shown within FIG. 5B, in some embodiments, the back of the tool holder body 501 comprises one or more pockets 511′.

As shown within FIG. 5C, in some embodiments, the primary storage compartment 503 comprises one or more internal pockets 517. Particularly, the primary storage compartment 503 is able to comprise any appropriately desired number of pockets.

FIG. 6 illustrates a tool holding system and device, in accordance with some embodiments. As shown within FIG. 6, the tool holder body 601 comprises a primary storage compartment 603 configured to removably store one or more tools and a secondary storage compartment 605 configured to removably store a parts bin 620 and a handle 609, such as described above.

As described above, the parts bin 620 is configured to removably receive one or more additional tools. As shown within FIG. 6, the flap 615 is in an open configuration and the parts bin 620 has been removed from the secondary storage compartment 605. As further shown within FIG. 6, a zipper 607 is used to open the flap 615 for accessing the secondary storage compartment 605. However, as described above, the flap 615 is able to comprise any appropriately desired material and configuration for covering the secondary storage compartment 605. In some embodiments, the secondary storage compartment 605 comprises a form fitting opening configured for receiving a complementary shaped parts bin 620. As shown within FIG. 6, the secondary storage compartment 605 is built into a body of the tool holder 601. As further shown within FIG. 6, in some embodiments, the parts bin 620 comprises a single compartment. However, as described below, the parts bin 620 is able to comprise any appropriately desired number of compartments.

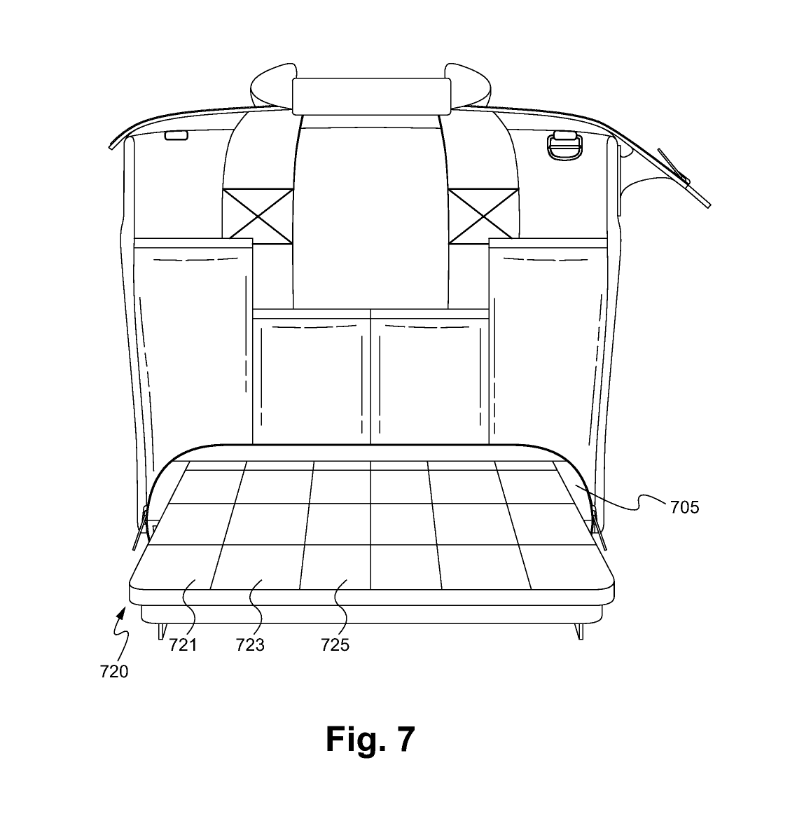

In some embodiments, such as shown within FIG. 7, the parts bin 720 comprises a plurality of compartments 721, 727, and 725 for removably storing one or more additional tools. Particularly, the parts bin 720 is able to comprise any appropriately desired amount and configuration of compartments for storing the one or more additional tools. As described above, in some embodiments the parts bin 720 is accessible from a front and a back of the tool holder body 701.

In use, a tool storage system and device, such as described above, has many applications. Particularly, the tool holder body is able to be manufactured from a variety of different materials and weights of materials configured for different tasks. Additionally, the exterior pockets and/or flap is able to be manufactured from different materials comprising one or more of leather, cotton, cotton/polyester blend, plastic, nylon, vinyl, neoprene, knit, and rubber. The primary storage compartment is able to be used to hold a variety of larger tools and accessories while the secondary storage compartment receives a parts bin capable of storing smaller tools and items, while allowing a user easy and convenient access to those objects. Particularly, it is advantageous to keep small parts next to the tools with which they are used while still keeping them separate for easy access. Additionally, the handle allows for easy transportation of the tool storage system and device. Specifically, the tool storage system and device is configured to carry a variety of different articles as desired. Consequently, the tool storage system and device as described herein has many advantages.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A tool holding system comprising:
a. a parts bin configured to removably hold one or more additional tools; and
b. a tool holder comprising:
i. a primary storage compartment for removably holding one or more tools; and
ii. a secondary storage compartment configured to removably receive the parts bin.

2. The tool holding system of claim 1, wherein the secondary storage compartment comprises a form fitting opening configured for receiving a complementary shaped parts bin.

3. The tool holding system of claim 1, wherein the parts bin is configured to hold one or more additional tools for use with the one or more tools removably held within the primary storage compartment.

4. The tool holding system of claim 1, wherein the primary storage compartment is closable.

5. The tool holding system of claim 1, wherein a flap removably covers the secondary storage compartment.

6. The tool holding system of claim 5, wherein the flap is one of foldable in place and zippable in place.

7. The tool holding system of claim 1, wherein the secondary storage compartment is built into the tool holder.

8. The tool holding system of claim 1, wherein the secondary storage compartment comprises a top wall so that items are able to be placed within the primary storage compartment when the parts bin is removed from the secondary storage compartment.

9. The tool holding system of claim 1, wherein the secondary storage compartment is accessible from a back side of the tool holder.

10. The tool holding system of claim 1, wherein the tool holder comprises one or more exterior pockets.

11. A tool holding device comprising:
a. a body comprising:
i. a primary storage compartment accessed from a top of the body and for removably holding one or more tools; and
ii. a secondary storage compartment built into the body and configured to removably receive a parts bin.

12. The tool holding device of claim 11, wherein the secondary storage compartment comprises a form fitting opening configured for receiving a complementary shaped parts bin.

13. The tool holding device of claim 11, wherein the parts bin is configured to hold one or more additional tools for use with the one or more tools removably held within the primary storage compartment.

14. The tool holding device of claim 11, wherein the primary storage compartment is closable.

15. The tool holding device of claim 11, wherein a flap covers the secondary storage compartment.

16. The tool holding device of claim 15, wherein the flap is one of foldable in place and zippable in place.

17. The tool holding device of claim 11, wherein the secondary storage compartment is built into the body.

18. The tool holding device of claim 11, wherein the secondary storage compartment comprises a top wall so that items are able to be placed within the primary storage compartment when the parts bin is removed from the secondary storage compartment.

19. The tool holding device of claim 11, wherein the secondary storage compartment is accessible from a back side of the tool holder.

20. The tool holding device of claim 11, wherein the tool holder comprises one or more exterior pockets.

21. A method of using a tool holder comprising:
a. removably storing one or more tools within a primary storage compartment of the tool holder;
b. removably inserting a parts bin into a secondary storage compartment of the tool holder, wherein the secondary storage compartment is built into a body of the tool holder.

22. The method of claim 21, wherein the parts bin is configured to hold one or more additional tools for use with the one or more tools removably held within the primary storage compartment.

23. The method of claim 21, further comprising closing primary storage compartment.

24. The method of claim 21, further comprising covering the secondary storage compartment with a flap.

25. The method of claim 24, wherein the flap is zippable in place.
